(19) United States
(12) Patent Application Publication
(10) Pub. No.: US 2025/0319434 A1
(43) Pub. Date: Oct. 16, 2025

(54) CARBON DIOXIDE-SEPARATING APPARATUS AND CARBON DIOXIDE CAPTURE AND STORAGE SYSTEM

(71) Applicant: KOREA UNIVERSITY RESEARCH AND BUSINESS FOUNDATION, Seoul (KR)

(72) Inventors: Seungkwan HONG, Yongin-si (KR); Seonkyu LEE, Seoul (KR); Jihun LIM, Seongnam-si (KR); Jiwook KWON, Goyang-si (KR); Onyu HA, Seoul (KR)

(73) Assignee: KOREA UNIVERSITY RESEARCH AND BUSINESS FOUNDATION, Seoul (KR)

(21) Appl. No.: 18/952,430

(22) Filed: Nov. 19, 2024

(30) Foreign Application Priority Data
Apr. 11, 2024 (KR) 10-2024-0048957

(51) Int. Cl. B01D 53/22; B01D 53/02; B01D 53/62; B01D 53/96

(52) U.S. Cl. CPC B01D 53/229; B01D 53/02; B01D 53/228; B01D 53/62; B01D 53/965; B01D 2053/222; B01D 2251/304; B01D 2251/306; B01D 2251/502; B01D 2251/506; B01D 2253/20; B01D 2257/504

(57) ABSTRACT

Proposed is an apparatus for separating CO2 gas captured with ammonia gas as an absorbent and the ammonia gas from a capture solution. The apparatus includes cation and anion exchange membranes spaced apart from each other to form a capture channel therebetween for a capture solution flow, cathode and anode current collector plates and their corresponding cation and anode exchange membranes forming cathode and anode channels therebetween, respectively. In the separate channels, basic and acidic solutions flow. Power applied to the collector plates drives ammonium and bicarbonate ions from the capture solution through the membranes, and then the ions convert into ammonia and CO2 gases in a chemical reaction, respectively. Through the power application with the basic and acidic solution flows through the corresponding channels, and a flow-conductive acid/base electrolytic separation method, gas separation without directly adding an acidic or basic solution to a capture solution is possible.

### CROSS REFERENCE TO RELATED APPLICATION

The present application claims priority to Korean Patent Application No. 10-2024-0048957, filed Apr. 11, 2024, the entire contents of which is incorporated herein for all purposes by this reference.

### BACKGROUND OF THE DISCLOSURE

### 1. Field of the Disclosure

The present disclosure relates to a carbon dioxide-separating apparatus and a carbon dioxide capture and storage system. More specifically, the present disclosure relates to a carbon dioxide-separating apparatus and a carbon dioxide capture and storage system for separating carbon dioxide gas captured by using an absorbent in a membrane stripping apparatus.

### 2. Description of the Related Art

Global warming is one of the biggest challenges facing humanity today. Regarding climate change, the Intergovernmental Panel on Climate Change (IPCC) recently emphasized that global temperature rise was required to be limited below 1.5° C. through management.

Carbon dioxide capture utilization and storage (CCUS), which is one of various strategies to reduce carbon dioxide emissions, is an important technique for achieving carbon neutralization. A process of CCUS is generally categorized into capture, stripping, and conversion stages respectively.

Carbon dioxide gas emitted from a flue gas is captured by using an absorbent in the capture stage. The absorbent with carbon captured is separated into an absorbent and carbon dioxide gas in the stripping stage, thereby the absorbent becomes recyclable. Lastly, the pure carbon dioxide gas separated in the stripping stage may be utilized in a variety of ways, including as an energy source (e.g., CO, CH₄, CH₃OH) and for enhanced oil recovery (EOR) in the carbon dioxide conversion stage.

Alcohol-based amines such as monoethanolamine (MEA), diethanolamine (DEA), and methyldiethanolamine (MDEA) are commonly used as the absorbent for carbon dioxide, and these alcohol-based amines have high absorption capacity and absorption rates. Currently, in the process of CCUS, especially in the absorbent regeneration process, saving energy is one of the most important issues.

However, the amine-based absorbent generally captures the carbon dioxide gas in a carbamate form, which requires a high temperature for absorbent regeneration. Accordingly, absorbents that do not produce carbamates, such as ionic liquids and highly alkaline liquids, have attracted attention.

A carbon dioxide capture system using an ammonia (NH₃) absorbent is a technique which has recently attracted attention in the process of CCUS. Ammonia is a well-known alkaline solution which may be obtained from various environmental industries such as in semiconductor production and wastewater treatment systems.

These industries are adopting ammonia recovery processes to achieve carbon dioxide neutralization and Zero Liquid Discharge (ZLD). On the basis of an acid-base reaction between a high pH solution and a target gas, ammonia may capture carbon dioxide gas from combustion gases.

The carbon dioxide gas in the flue gas diffuses into an ammonia solution due to the difference in a carbon dioxide partial pressure between the liquid state and the gaseous state. The carbon dioxide gas dissolved in ammonia is then immediately converted into HCO³⁻ and CO₃²⁻ forms. Most carbon dioxide gas dissolved is captured in the carbonate form, but the dissolved carbon dioxide gas may also be stored in solid forms such as NH₄COONH₂, (NH₄)₂CO₃, and NH₄HCO₃.

Recently, to reduce energy consumption, which is a major issue in commercializing the process of CCUS, an absorbent recovery method has been applied to a membrane contactor. The membrane contactor may be operated at a relatively low temperature (80° C. to 100° C.), unlike a conventional stripping tower process which is required to be carried out at a high temperature of 120° C. to 200° C. In addition, the membrane contactor is capable of improving mass transfer of carbon dioxide gas since the membrane contactor increases the contact area between the liquid and the gas.

However, research on absorbent recovery in the ammonia absorbent-based process of CCUS remains insufficient. The utilization of NH₄HCO₃ solution, which is a by-product from the carbon dioxide capture process, has been proposed primarily for fertilizer purposes at this point. In this situation, for sustainability, it is desirable to reuse ammonia for carbon dioxide reabsorption.

Since ammonia induces a decrease in pH when absorbing carbon dioxide gas, additional processes are essential to effectively improve the reusability of a carbon dioxide removal absorbent. In this situation, to recover the ammonia absorbent, pH is required to be raised, but to effectively remove carbon dioxide gas, pH is required to be lowered.

Therefore, to improve the performance with carbon dioxide gas, chemical administration is needed to adjust the pH. This chemical administration means adding an acidic solution to recover the ammonia absorbent and adding an alkaline solution again to recover carbon dioxide gas.

However, the chemical administration has the disadvantage of having to use chemical solutions, as well as increasing the size of the entire system since a two-stage process of raising and lowering the pH is introduced.

### SUMMARY OF THE DISCLOSURE

Accordingly, the present disclosure is devised to solve the problems. One purpose of the present disclosure is to provide a carbon dioxide-separating apparatus and a carbon dioxide capture and storage system capable of separating carbon dioxide gas and an absorbent without chemical administration for pH adjustment.

In addition, another purpose of the present disclosure is to provide a carbon dioxide-separating apparatus and a carbon dioxide capture and storage system which selectively and simultaneously separate carbon dioxide gas and an absorbent in a single process without chemical administration, thereby reducing the size of the entire system.

The purposes may be fulfilled with a carbon dioxide-separating apparatus for separating carbon dioxide gas and ammonia gas from a capture solution, in which the carbon dioxide gas has been captured by using the ammonia gas as an absorbent according to one embodiment of the present disclosure. The carbon dioxide-separating apparatus may include a cation exchange membrane and an anion exchange membrane spaced apart from each other to form a capture channel, through which a capture solution flows, therebetween, a cathode current collector plate with a cathode channel formed between itself and the cation exchange membrane, and an anode current collector plate with an anode channel formed between itself and the anion exchange membrane. A basic solution flows in the cathode channel, and an acidic solution flows in the anode channel. When power is applied to the cathode current collector plate and the anode current collector plate, ammonium ions in the capture solution pass through the cation exchange membrane and move to the cathode channel, and bicarbonate ions in the capture solution pass through the anion exchange membrane and move to the anode channel. The ammonium ions that have moved to the cathode channel undergo a chemical reaction in the basic solution and are converted to ammonia gas. The bicarbonate ions that have moved to the anode channel undergo a chemical reaction in the acidic solution and are converted to carbon dioxide gas.

Herein, the basic solution may include a sodium hydroxide solution or a potassium hydroxide solution. The acidic solution may include a sulfuric acid solution or a hydrochloric acid solution.

In addition, the carbon dioxide-separating apparatus may further include a first membrane contactor which separates the ammonia gas from the basic solution flowing through the cathode channel, and a second membrane contactor which separates the carbon dioxide gas from the acidic solution flowing through the anode channel.

The carbon dioxide-separating apparatus may further include a basic solution supply unit supplying the basic solution to the cathode channel and an acidic solution supply unit supplying the acidic solution to the anode channel. The basic solution from which the ammonia gas is separated in the first membrane contactor may be circulated to the basic solution supply unit. The acidic solution from which the carbon dioxide gas is separated in the second membrane contactor may be circulated to the acidic solution supply unit.

The cathode channel may be formed to be exposed on a plate surface of the cathode current collector plate facing the cation exchange membrane. Thus, the cation exchange membrane may be formed in contact with the corresponding plate surface. The anode channel may be formed to be exposed on a plate surface of the anode current collector plate facing the anion exchange membrane. Thus, the anion exchange membrane may be formed in contact with the corresponding plate surface.

The cathode channel and the anode channel may be formed in a zigzag shape on the plate surfaces of the cathode current collector plate and the anode current collector plate, respectively.

Meanwhile, the purposes may be fulfilled with a carbon dioxide capture and storage system according to another embodiment of the present disclosure. The carbon dioxide capture and storage system may include a membrane stripping apparatus which captures carbon dioxide by using ammonia gas as an absorbent and the carbon dioxide-separating apparatus which receives the capture solution, in which carbon dioxide gas is captured in the membrane stripping apparatus, and separates the carbon dioxide gas from the ammonia gas. The ammonia gas separated in the first membrane contactor of the carbon dioxide-separating apparatus may be circulated as the absorbent for the membrane stripping apparatus.

According to the present disclosure based on the configuration, by applying power while flowing a basic solution and an acidic solution through a cathode channel and an anode channel, respectively, thereby following the flow-conductive acid/base electrolytic separation method, ammonia gas and carbon dioxide gas can be separated without directly adding an acidic or basic solution to a capture solution.

In addition, ammonia gas and carbon dioxide gas can be selectively and simultaneously separated in one process, making it possible to reduce the size of the overall system.

In addition, continuous operation becomes possible by reusing an absorbent used to capture the carbon dioxide gas.

### BRIEF DESCRIPTION OF THE DRAWINGS

FIG. 1 shows a diagram showing the configuration of a carbon dioxide-separating apparatus according to one embodiment of the present disclosure;

FIG. 2 shows a diagram to explain an operating principle of the carbon dioxide-separating apparatus according to another embodiment of the present disclosure;

FIG. 3 shows a diagram showing the configuration of a carbon dioxide capture and storage system according to a further embodiment of the present disclosure; and

FIGS. 4A to 4D show diagrams to explain experimental results of a carbon dioxide-separating apparatus according to a yet further embodiment of the present disclosure.

### DESCRIPTION OF THE PREFERRED EMBODIMENTS

This work was supported by the National Research Foundation of Korea (NRF) grant funded by the Korea government (MSIT) (No. 2022M3J7A1066428 and No. NRF-2021R1A5A1032433).

Advantages and features of the present disclosure and a method to achieve the advantages and features will become clear by referring to the embodiments described in detail below along with the accompanying drawings. However, the present disclosure is not limited to the embodiments disclosed below but may be implemented in various different forms. These embodiments are provided solely to ensure that the disclosure of the present disclosure is complete and to fully inform those skilled in the art of the scope of the present disclosure. The present disclosure is defined only by the scope of the claims.

The terminology used herein is for describing embodiments and is not intended to limit the present disclosure. As used herein, singular forms also include plural forms, unless specifically stated otherwise in the context. As used in the specification, “comprises” and/or “comprising” does not exclude the presence or addition of one or more other elements in addition to the mentioned elements. Like reference numerals refer to like elements throughout the specification, and “and/or” includes each and every combination of one or more of the referenced elements. Although “first” and “second” are used to describe various components, these components are of course not limited by these terms. These terms are merely used to distinguish one component from another. Therefore, it goes without saying that the first component mentioned below may also be a second component within the technical spirit of the present disclosure.

Unless otherwise defined, all terms (including technical and scientific terms) used in this specification may be used with meanings commonly understood by those skilled in the art to which the present disclosure pertains. Additionally, terms defined in commonly used dictionaries are not to be interpreted ideally or excessively unless clearly specifically defined.

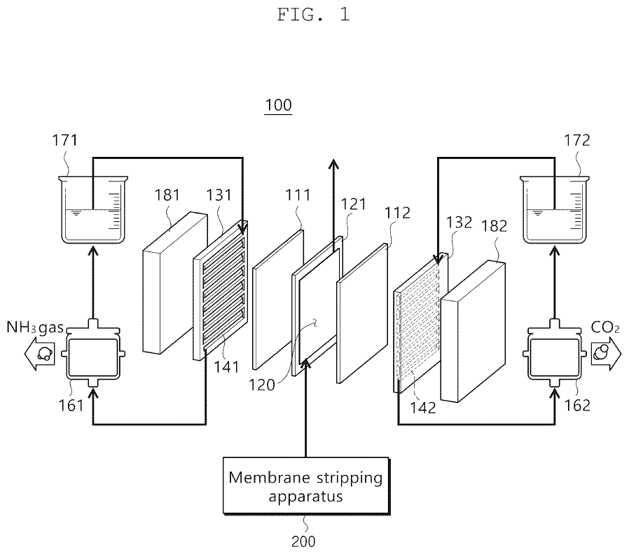

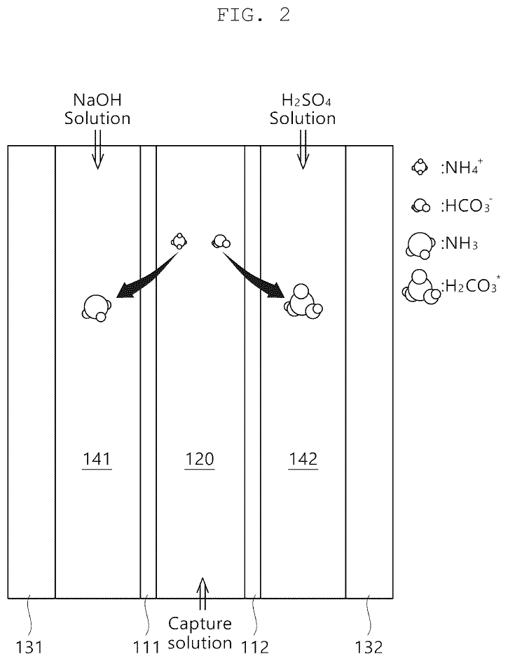

FIG. 1 shows a diagram showing the configuration of a carbon dioxide-separating apparatus 100 according to one embodiment of the present disclosure. FIG. 2 shows a diagram to explain an operating principle of the carbon dioxide-separating apparatus 100 according to another embodiment of the present disclosure.

Referring to FIGS. 1 and 2, a capture solution is introduced into the carbon dioxide-separating apparatus 100 according to one embodiment of the present disclosure, thereby ammonia gas and carbon dioxide gas may be separated from the capture solution. Herein, the capture solution is produced by capturing carbon dioxide gas by using ammonia gas as an absorbent in the membrane stripping apparatus 200, which will be described later, and then the capture solution is delivered to the carbon oxide-separating apparatus 100.

The carbon oxide-separating apparatus 100 according to another embodiment of the present disclosure may include a cation exchange membrane 111, an anion exchange membrane 112, a cathode current collector plate 131, and an anode current collector plate 132.

The cation exchange membrane 111 according to a further embodiment of the present disclosure selectively transmits cations, and the anion exchange membrane 112 selectively transmits anions.

Herein, the cation exchange membrane 111 and the anion exchange membrane 112 are spaced apart from each other to form a capture channel 120 therebetween. The capture solution flows in the capture channel 120. In a yet further embodiment of the present disclosure, the cation exchange membrane 111 and the anion exchange membrane 112 may be spaced apart from each other by a spacer 121. A space is formed within the spacer 121, open on both sides towards the cation exchange membrane 111 and the anion exchange membrane 112. By attaching the cation exchange membrane 111 and the anion exchange membrane 112 to the corresponding sides of the spacer 121 through the open space, a capture channel 120 may be formed.

According to a still yet further embodiment of the present disclosure, the cathode current collector plate 131 may have a cathode channel 141 formed between itself and the cation exchange membrane 111, and the anode current collector plate 132 may have an anode channel 142 formed between itself and the anion exchange membrane 112.

Herein, a basic solution may flow in the cathode channel 141, and an acidic solution may flow through the anode channel 142.

According to a still yet further embodiment, both sides of the cathode current collector plate 131 and the anode current collector plate 132 may be blocked by a first-end plate 181 and a second-end plate 182.

Based on the configuration, when power is applied to the cathode current collector plate 131 and the anode current collector plate 132, that is, when (−) power is applied to the cathode current collector plate 131 and (+) power is applied to the anode current collector plate 132, due to electrical attraction, the cations in the capture channel 120 pass through the cation exchange membrane 111 and move to the basic solution flowing through the cathode channel 141, whereas the anions in the capture channel pass through the anion exchange membrane 112 and move to the acidic solution flowing through the anode channel 142.

According to a still yet further embodiment, the ammonia gas exists in the form of ammonium ions (NH₄⁺) in the capture solution, and the carbon dioxide gas exists in the form of bicarbonate ions (HCO⁻). Depending on the application of power to the cathode current collector plate 131 and the anode current collector plate 132, the ammonium ions pass through the cation exchange membrane 111 and move to the basic solution, and the bicarbonate ions pass through the anion exchange membrane 112 and move to the acidic solution.

Herein, the ammonium ions that have moved to the cathode channel 141 undergo a chemical reaction under the influence of pH in the basic solution and are converted into ammonia gas. The bicarbonate ions that have moved to the anode channel 142 undergo a chemical reaction in the acidic solution and are converted into carbon dioxide gas. Thus, it is possible to separate carbon dioxide gas and ammonia gas from the capture solution.

Based on the configuration, by applying power while flowing the basic solution and the acidic solution through the cathode channel 141 and the anode channel 142, respectively, thereby following the flow-conductive acid/base electrolytic separation method, it is possible to separate ammonia gas and carbon dioxide gas without adding an acidic or basic solution directly to the capture solution.

In addition, ammonia gas and carbon dioxide gas may be selectively and simultaneously separated in one process, making it possible to reduce the size of the overall system.

According to a still yet further embodiment, the basic solution flowing through the cathode channel 141 may be a sodium hydroxide (NaOH) solution. The ammonium ions and sodium hydroxide may react and the ammonium ions may be converted into ammonia gas.

The acidic solution flowing through the anode channel 142 may be a sulfuric acid (H₂SO₄) solution. The bicarbonate ions and sulfuric acid may react, and the bicarbonate ions may be converted into carbon dioxide gas.

Herein, it is only an example that the basic solution is a sodium hydroxide solution and the acidic solution is a sulfuric acid solution. It goes without saying that other solutions, for example, a potassium hydroxide (KOH) solution or a hydrochloric acid (HCl) solution, may be applied when the other solutions may react with the ammonium ions and bicarbonate ions to convert the ammonium ions and bicarbonate ions into ammonia gas and carbon dioxide gas, respectively.

Meanwhile, according to a still yet further embodiment of the present disclosure, the carbon dioxide-separating apparatus 100 may include a first membrane contactor 161 and a second membrane contactor 162.

According to a still yet further embodiment of the present disclosure, the first membrane contactor 161 separates ammonia gas from the basic solution flowing through the cathode channel 141, the ammonia gas being converted from the ammonium ions, which have moved from the capture solution. The second membrane contactor 162 separates carbon dioxide gas from the acidic solution flowing through the anode channel 142, the carbon dioxide gas being converted from the bicarbonate ions, which have moved from the capture solution.

According to a still yet further embodiment, the first membrane contactor 161 and the second membrane contactor 162 allow the liquid to pass through, whereas the first membrane contactor 161 and the second membrane contactor 162 do not allow the gas to pass through. Thus, the first membrane contactor 161 and the second membrane contactor 162 may separate the ammonia gas and the carbon dioxide gas in a gas state from the basic solution and the acidic solution in a liquid state, respectively. The first membrane contactor 161 and the second membrane contactor 162 may separate the liquid and the gas through a vacuum method.

According to a still yet further embodiment of the present disclosure, the carbon dioxide-separating apparatus 100 may include a basic solution supply unit 171 and an acidic solution supply unit 172.

The basic solution supply unit 171 may supply a basic solution to the cathode channel 141, and the acidic solution supply unit 172 may supply an acidic solution to the anode channel 142.

According to a still yet further embodiment, the basic solution from which the ammonia gas is separated in the first membrane contactor 161 is circulated to the basic solution supply unit 171. The acidic solution from which the carbon dioxide gas is separated in the second membrane contactor 162 may be circulated to the acidic solution supply unit 172.

Through this, the basic and acidic solutions supplied to separate the ammonia gas and the carbon dioxide gas from the capture solution are recirculated and reused after the ammonia gas and the carbon dioxide gas are separated. Thus, continuous operation is possible without adding additional basic or acidic solutions.

Meanwhile, as shown in FIG. 1, according to a still yet further embodiment of the present disclosure, the cathode channel 141 may be formed to be exposed on a plate surface of the cathode current collector plate 131 facing the cation exchange membrane 111. By attaching the cation exchange membrane 111 to the corresponding plate surface of the cathode current collector plate 131, the cathode channel 141 may be formed.

Symmetrically, the anode channel 142 may be formed to be exposed on a plate surface of the anode current collector plate 132 facing the anion exchange membrane 112. By attaching the anion exchange membrane 112 to the corresponding plate surface of the anode current collector plate 132, an anode channel 142 may be formed.

According to a still yet further embodiment, the cathode channel 141 and the anode channel 142 are formed in a zigzag shape on the plates of the cathode current collector 131 and the anode current collector 132, respectively, thereby it is possible to increase the contact area with the capture solution through the cation exchange membrane 111 and the anion exchange membrane 112, respectively.

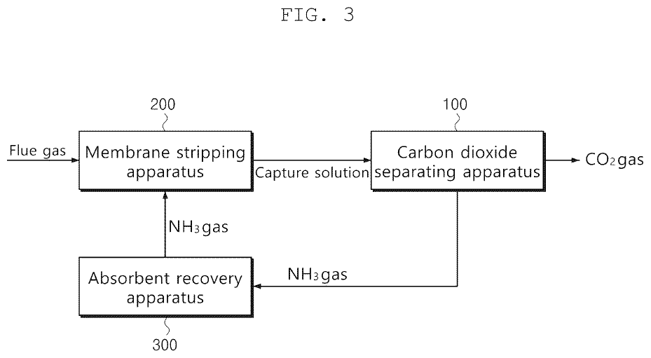

FIG. 3 shows a diagram showing the configuration of a carbon dioxide capture and storage system 10 according to a further embodiment of the present disclosure.

Referring to FIG. 3, according to a still yet further embodiment of the present disclosure, the carbon dioxide capture and storage system 10 may include a membrane stripping apparatus 200, a carbon dioxide-separating apparatus 100, and an absorbent recovery apparatus 300.

According to a still yet further embodiment of the present disclosure, the membrane stripping apparatus 200 may capture carbon dioxide gas by using ammonia gas as an absorbent. Herein, the membrane stripping apparatus 200 may be implemented in various forms to capture the carbon dioxide gas by using the ammonia gas as an absorbent. The technical idea of the present disclosure is not limited to the configuration of the membrane stripping apparatus 200.

According to a still yet further embodiment of the present disclosure, the carbon dioxide-separating apparatus 100 receives a capture solution, in which carbon dioxide gas is captured from the membrane stripping apparatus 200, and separates carbon dioxide gas and ammonia gas, as described above. Herein, the carbon dioxide and the ammonia separated in the carbon dioxide-separating apparatus 100 are in the form of gas, as described above.

According to a still yet further embodiment of the present disclosure, the ammonia gas separated in the first membrane contactor 161 of the carbon dioxide-separating apparatus 100 may be circulated as an absorbent for the membrane stripping apparatus 200. That is, the absorbent recovery apparatus 300 may recover the ammonia gas separated in the first membrane contactor 161 of the carbon dioxide-separating apparatus 100 and re-supply the ammonia gas as an absorbent for capturing carbon dioxide gas in the membrane stripping apparatus 200.

Based on the configuration, continuous operation becomes possible by reusing the absorbent used to capture the carbon dioxide gas.

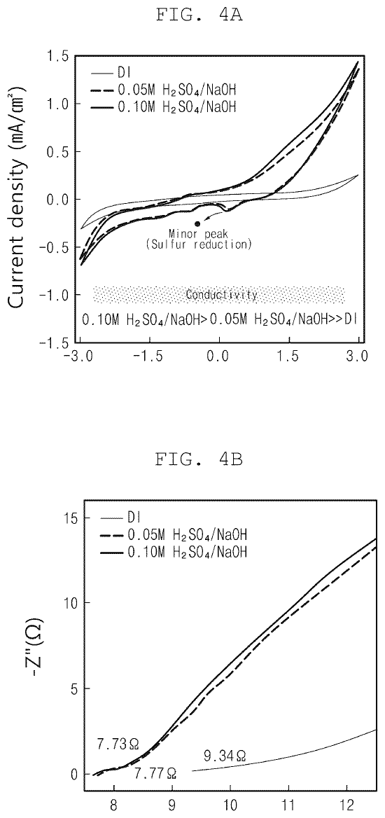

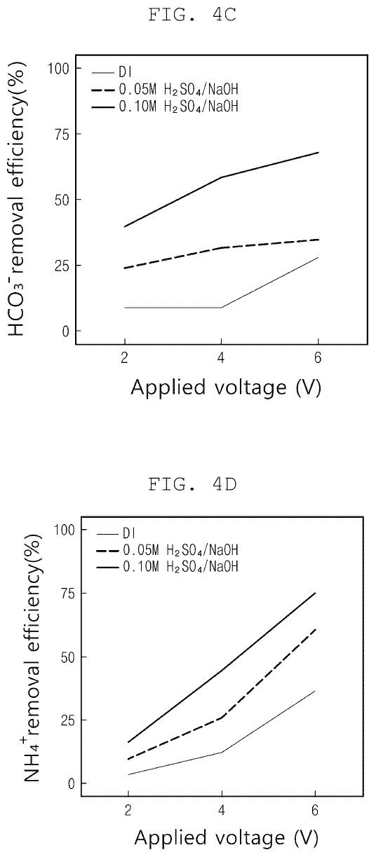

Hereinafter, according to examples of the present disclosure, experimental results of the carbon dioxide-separating apparatus 100 will be described with reference to FIGS. 4A to 4D.

According to an example of the present disclosure, the performance of the carbon dioxide-separating apparatus 100 was confirmed through electrical properties of the carbon dioxide-separating apparatus and deionization experiments. First, the concentrations of the acidic and basic solutions were determined through comparative analysis of conductivity and deionization performance under various conditions.

In the experiment, a 0.1M NH₄HCO₃ solution was used as a capture solution. The concentrations of acidic/basic solutions were adjusted to a DI solution, a 0.05 M H₂SO₄/NaOH solution, and a 0.1 M H₂SO₄/NaOH solution, respectively.

Charge transfer resistance and electrically active surface area were related to a cyclic voltammetry curve (CV curve). The results of the CV curves for the solutions are shown in FIG. 4A. As shown in FIG. 4A, it was confirmed that the conductivity increased depending on the concentrations of the acidic/basic solutions. Additionally, it was confirmed that there was a significant difference in CV capacitance between the DI solution and the 0.05 M H₂SO₄/NaOH solution.

The CV capacitance of the 0.1 M H₂SO₄/NaOH solution improved the CV capacitance of the carbon dioxide-separating apparatus 100. Additionally, small peaks caused by sulfur reduction were observed in the CV curves for the 0.05 M H₂SO₄/NaOH solution and the 0.1 M H₂SO₄/NaOH solution, but these were negligible.

Meanwhile, the overall electrical resistance of the carbon dioxide-separating apparatus 100 was evaluated through electrochemical impedance spectroscopy (EIS) analysis. FIG. 4B shows the results of EIS analysis by varying the concentration of an H₂SO₄/NaOH solution.

R1 values, which represent the overall system resistance, were observed to be 7.73, 7.77, and 9.34Ω for the 0.1 M H₂SO₄/NaOH solution, the 0.05 M H₂SO₄/NaOH solution, and the DI solution, respectively. Therefore, the excellent electrical conductivity of the carbon dioxide-separating apparatus 100 appeared in the 0.1 M H₂SO₄/NaOH solution, which could lead to improved deionization performance.

Deionization performance was significantly improved depending on acid/base concentration and applied voltage. The removal efficiency of HCO₃⁻ and NH₄⁺ ions was measured through ion chromatography and total inorganic carbon analysis.

First, it was confirmed that HCO₃⁻ ions were not effectively separated when using the DI solution, as shown in FIG. 4C. When the applied voltage was increased to a range of 2 to 6 V, the performance slightly increased to a range of 8.8% to 27.9%. However, the HCO₃⁻ removal efficiency was greatly improved in the 0.05 M H₂SO₄/NaOH solution and the 0.1 M H₂SO₄/NaOH solution. The HCO₃⁻ removal efficiency of the 0.05 M H₂SO₄/NaOH solution and the 0.1 M H₂SO₄/NaOH solution were 23.03%, 31.72%, 34.6%, 38.94%, 58.51%, and 67.84% at 2, 4, and 6 V, respectively.

Likewise, the NH₄⁺ removal efficiency of showed a similar trend to that of HCO₃⁻ ions. FIG. 4D shows the NH₄⁺ removal efficiency. The performance was in a range of 3.47% and 36.74% (2 to 6 V) in the DI solution. The NH₄⁺ removal efficiency of the 0.05 M H₂SO₄/NaOH solution and 0.1 M H₂SO₄/NaOH solution were 9.91%, 24.73%, and 60.44%, and 16.09%, 44.31%, and 74.95% at 2, 4, and 6 V, respectively. Therefore, it was confirmed that the increase in conductivity caused by the increase in acid/base concentration significantly improved the deionization performance by about two times compared to the DI solution.

Several examples of the present disclosure have been shown and described, but those skilled in the art of the art to which the present disclosure pertains will recognize that modifications can be made to the examples without departing from the principles or spirit of the present disclosure. The scope of the present disclosure will be determined by the appended claims and their equivalents.

What is claimed is:

1. A carbon dioxide-separating apparatus for separating carbon dioxide gas and ammonia gas from a capture solution, in which the carbon dioxide gas has been captured by using the ammonia gas as an absorbent, the carbon dioxide-separating apparatus comprising:
a cation exchange membrane and an anion exchange membrane spaced apart from each other to form a capture channel, through which a capture solution flows, therebetween,
a cathode current collector plate with a cathode channel formed between itself and the cation exchange membrane,
an anode current collector plate with an anode channel formed between itself and the anion exchange membrane,
wherein a basic solution flows in the cathode channel, and an acidic solution flows in the anode channel,
wherein when power is applied to the cathode current collector plate and the anode current collector plate, ammonium ions in the capture solution pass through the cation exchange membrane and move to the cathode channel, and
bicarbonate ions in the capture solution pass through the anion exchange membrane and move to the anode channel,
wherein the ammonium ions that have moved to the cathode channel undergo a chemical reaction in the basic solution and are converted to ammonia gas, and
the bicarbonate ions that have moved to the anode channel undergo a chemical reaction in the acidic solution and are converted to carbon dioxide gas.

2. The apparatus of claim 1, wherein the basic solution comprises a sodium hydroxide solution or a potassium hydroxide solution, and
the acidic solution comprises a sulfuric acid solution or a hydrochloric acid solution.

3. The apparatus of claim 1, wherein the carbon dioxide-separating apparatus further comprises:
a first membrane contactor which separates the ammonia gas from the basic solution flowing through the cathode channel, and
a second membrane contactor which separates the carbon dioxide gas from the acidic solution flowing through the anode channel.

4. The apparatus of claim 3, wherein the carbon dioxide-separating apparatus further comprises:
a basic solution supply unit supplying the basic solution to the cathode channel and
an acidic solution supply unit supplying the acidic solution to the anode channel,
wherein the basic solution from which the ammonia gas is separated in the first membrane contactor is circulated to the basic solution supply unit, and
the acidic solution from which the carbon dioxide gas is separated in the second membrane contactor is circulated to the acidic solution supply unit.

5. The apparatus of claim 4, wherein the cathode channel is formed to be exposed on a plate surface of the cathode current collector plate facing the cation exchange membrane, thereby the exchange membrane is formed in contact with the cation corresponding plate surface, and
the anode channel is formed to be exposed on a plate surface of the anode current collector plate facing the anion exchange membrane, thereby the anion exchange membrane is formed in contact with the corresponding plate surface.

6. The apparatus of claim 5, wherein the cathode channel and the anode channel are formed in a zigzag shape on the plate surfaces of the cathode current collector plate and the anode current collector plate, respectively.

7. A carbon dioxide capture and storage system, comprising:
a membrane stripping apparatus which captures carbon dioxide by using ammonia gas as an absorbent and
the carbon dioxide-separating apparatus of claim 3, which receives the capture solution, in which carbon dioxide gas is captured in the membrane stripping apparatus, and separates the carbon dioxide gas from the ammonia gas,
wherein the ammonia gas separated in the first membrane contactor of the carbon dioxide-separating apparatus is circulated as the absorbent for the membrane stripping apparatus.
